(19) United States
(12) Patent Application Publication
(10) Pub. No.: US 2024/0300062 A1
(43) Pub. Date: Sep. 12, 2024

(54) PROCESSING MACHINE WITH SUCTION DEVICE, AND METHOD

(71) Applicant: HOMAG GmbH, Schopfloch (DE)

(72) Inventors: Carsten KANITZ, Rottenburg (DE); Sven SCHWEIZER, Rosenfeld (DE)

(21) Appl. No.: 18/281,531

(22) PCT Filed: Mar. 7, 2022
(86) PCT No.: PCT/EP2022/055701

§ 371 Date: Sep. 11, 2023

(30) Foreign Application Priority Data
Mar. 11, 2021 (DE) 10 2021 105 931.3

(51) Int. Cl. B23Q 11/00; A47L 7/00

(52) U.S. Cl. CPC B23Q 11/0046; A47L 7/0095

(57) ABSTRACT

The invention relates to a processing machine having a suction device, and a method. Such a processing machine can be used to machine workpieces made of wood, wood materials or the like, as is the case in the furniture or components industry, for example.

### TECHNICAL FIELD

The invention relates to a processing machine having a suction device, and a method. Such a processing machine can be used to machine workpieces made of wood, wood materials or the like, as is the case in the furniture or components industry, for example.

### PRIOR ART

During the machining of workpieces, machining residues—in particular chips, dust, residual pieces or the like—are produced which have to be removed from the processing machine in the course of cleaning. In this respect, it is known to use a suction device that sucks off such machining residues during the machining of a workpiece.

Such a suction device is in fluid connection with a so-called main hose which provides a suction air flow. Such a main hose can be connected to a central suction system. In the processing machine comprising a plurality of machining units, a plurality of connecting hoses can be provided starting from the main hose, wherein each connecting hose is guided to a specific machining unit and, when a fluid coupling has been established between the connecting hose and the main hose, provides a suction air flow at this machining unit.

A fluid connection between the main hose and the selected connecting hose can be established by means of flaps, for example. However, such a flap mechanism has a rather low energy efficiency.

In order to increase energy efficiency, a processing machine having a suction device is known from EP 2 193 877 A1, in which one end of a main hose connected to the support member can be moved along the support member. Thus, the main hose can be moved from one connecting hose to the next connecting hose in order to provide a suction air flow for a specific connecting hose as required. The air flow is conducted directly and straight from the main hose to the connecting hose. In other words, the air flow is not diverted, and losses in a flap mechanism due to locations that are not completely sealed are reduced or avoided. As a result, the efficiency of suction is significantly improved.

Although the suction device described in EP 2 193 877 A1 has proven its worth, it is apparent that due to the limited installation space at the support member, an extension of the suction device is difficult to achieve without negatively affecting energy efficiency.

### DESCRIPTION OF THE INVENTION

It is an object of the invention to provide a processing machine having a suction device, with which the range of applications for sucking off machining residues or the like can be extended with energy-efficient flow guidance and while maintaining a compact design.

Claim 1 provides such a processing machine. Further preferred embodiments are specified in the dependent claims. The invention further relates to a method of operating a suction device.

The processing machine according to the invention has the advantage that further connection options are implemented. The positions of the individual connections are no longer arranged in a row, but can be set up in different directions and/or offset. Thus, the installation space can be better utilized. Moreover, complicated hose installations can be avoided with an extended range of applications.

The processing machine having a suction device for sucking off machining residues such as chips, dust or residual pieces comprises: a first connector for a main fluid line, and a plurality of second connectors for connecting fluid lines, wherein the first connector can be moved in a first direction such that a fluid connection with at least one of the second connectors can be established. The first connector can also be moved in a second direction, the second direction crossing the first direction.

Purely by way of example, the second direction can cross the first direction perpendicularly or obliquely.

A “fluid connection” or similar features mean that a flow can be conducted from one section to another section. For example, a suction air flow can be conducted from one section to another section. When the first connector is moved such that a fluid connection with at least one of the second connectors can be established, a suction air flow can be conducted from the first connector to the second connector or vice versa.

A fluid line, such as a main fluid line or a connecting fluid line, can in particular be a hose or a tube, for example a telescopic tube or tube pieces that can be moved into/toward one another.

It is also possible to interrupt a fluid connection by a relative movement between the first connector and the second connectors and thus to stop a suction or to establish a different connection.

According to one embodiment, the processing machine comprises a first drive unit, in particular a pneumatic cylinder, a hydraulic cylinder and/or a servomotor, for moving the first connector in the first direction. Thus, a precisely timed, positionally accurate movement can be carried out. In addition, it is possible to carry out the movement using a control command and thus to integrate it into the machining procedure.

According to a further embodiment, the processing machine comprises a second drive unit, in particular a pneumatic cylinder, a hydraulic cylinder and/or a servomotor, for moving the second connector in the second direction. The second drive unit has similar advantages as the first drive unit.

The aforementioned second direction can be a straight or curved direction in order to move the first connector accordingly.

According to a preferred embodiment, the first connector can be accommodated on a connector base by means of at least one rail such that the first connector can be moved in the first direction, the connector base being able to be moved in the second direction. Thus, a robust and low-maintenance design is provided.

According to a further embodiment, the processing machine comprises at least a third connector, wherein a fluid connection can be established between the first connector and the third connector by a movement in the second direction. Thus, the variability of the processing machine can be increased further with shortened switching times.

The second connectors can be arranged in a row, and the third connector can be arranged adjacent to the row of the second connectors. This configuration allows a compact design and thus also shortened switching times between a second connector and the third connector.

According to a further embodiment, the processing machine comprises a cleaning unit which can be supplied with a suction air flow by means of a connecting fluid line connected to the third connector. The cleaning unit can be fixed to the safety housing. Moreover, the cleaning unit can provide an additional cleaning function after a machining operation. The suction air flow can be concentrated at a machining unit or can be conducted in a certain direction in order to increase the cleaning effect.

According to a further embodiment, the processing machine comprises a support member for accommodating the first connector. In this respect, it can furthermore be provided that the second connectors are fixed to or formed on the support member.

In a further variant, the support member can be moved along a beam-shaped base of the processing machine. Additionally or alternatively, the support member comprises a resting element which is configured, at least in sections, in a plate-shaped manner. Thus, the resting element can form a resting plane for the first connector.

Moreover, a plurality of machining units can be provided, wherein the machining units are each in fluid connection with one of the second connectors by means of a connecting fluid line. Thus, the corresponding machining unit can be supplied with a suction air flow.

The invention further relates to a method of operating a suction device. The method comprises the following steps: moving a first connector for a main fluid line in a first direction in order to establish a fluid connection with at least one second connector; and moving the first connector in a second direction, the second direction crossing the first direction.

It is therefore possible, for example, to interrupt a fluid connection by a relative movement between the first connector and the second connectors and thus to stop a suction or to establish a different connection, for example with a third connector.

Moreover, the method can be used during operation of a processing machine according to any one of the previous aspects.

The first connector, by moving in the second direction, can be positioned such that the first connector can be connected to a third connector. Thus, the variability can be increased further. Moreover, a fluid connection can be established between the first connector and the third connector by a movement in the second direction. Thus, the switching times can be shortened.

The second direction can be a straight or curved direction in order to move the first connector accordingly.

Moreover, after the fluid connection has been established, a suction air flow can be provided with which machining residues—in particular chips, dust, residual pieces or the like—can be removed.

### BRIEF DESCRIPTION OF THE DRAWINGS

Further features and advantages are apparent from the following description of embodiments with reference to the enclosed drawings.

FIG. 1 shows a perspective view of a device according to a first embodiment in a first operating position.

FIG. 2 shows the device according to the first embodiment in a second operating position.

FIG. 3 shows another perspective view of the device according to a first embodiment to illustrate a cleaning unit.

FIG. 4 shows a perspective view of a device according to a second embodiment in a second operating position.

FIG. 5 shows a perspective view of the device according to the second embodiment.

### DESCRIPTION OF EMBODIMENTS

Identical reference numbers specified in different figures designate identical, corresponding or functionally similar elements.

The embodiments described below relate to processing machines that can be used in particular for machining workpieces made of wood, wood materials, composite materials or the like. Since machining operations are or can be carried out at least in part on one or more workpieces using such processing machines, machining residues—in particular chips, dust or residual pieces—are produced which have to be removed from the processing machine. Other manufacturing processes, such as coating a workpiece or joining workpieces, can also lead to machining residues such as dust, which also have to be removed.

During cleaning, such machining residues are to be removed as completely as possible from the machining area of the processing machine. Accordingly, a suction air flow can be assigned to each of a plurality of machining units in that a fluid coupling can be established between a main hose and a connecting hose. This allows a targeted suction during operation of a specific machining unit, for example a drilling unit.

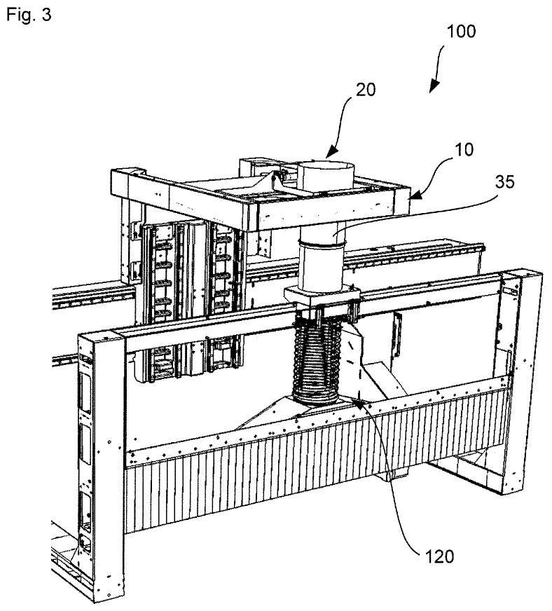

Moreover, a processing machine according to the embodiments can be provided with a cleaning unit which is fixed to the safety housing and provides an additional cleaning function after a machining operation. Such a cleaning unit 120 is shown, by way of example, with reference to FIG. 3. However, instead of the cleaning unit 120, a different unit can also be supplied with a suction air flow.

A main hose and a connecting hose are examples of a fluid line. Such a fluid line can also be configured as a tube, in particular as a telescopic tube, as tube pieces that can be moved into/toward one another, or the like.

A processing machine 100 according to a first embodiment comprises a beam-shaped support 110 having a guide rail 111. A support member 10 which can be moved along the guide rail 111 is attached to the beam-shaped support 111. Machining units (not shown) are attached to the support member 10.

The support member 10 comprises frame elements 12 which extend away from the beam-shaped support 110. The support member 10 further comprises attachment areas 13 at the end portion of the frame elements 12 facing the beam-shaped support 110. At the attachment areas 13, the support member 10 is coupled to the guide rail 111. A resting element 11 extends between the frame elements 12, which is configured, at least in sections, in a plate-shaped manner in order to form a resting plane.

A connector base 24 is accommodated on the resting element 11, which accommodates two rails 23 extending in a first direction. The connector base 24 further supports a first connector 20 for a main hose (not shown).

The first connector 20 comprises a connection unit 21 to which the main hose can be coupled. Moreover, a connection support 22 is provided which accommodates the connection unit 21 and has a sliding mechanism on the side facing the connector base 24, so that the connection support 22 can be moved along the rails 23.

The connector base 24 is connected to the resting element 11 at rails 25, so that a relative movement of the connector base 24 to the resting element 11 is made possible.

The resting element 11 comprises a plurality of second connectors 30, to which a connecting hose can be attached for connecting each of them to a machining unit. The second connectors 30 are arranged in a row: When the first connector 20 is moved along the rails 23, the first connector 20 can be aligned with and thus coupled to one of the second connectors 30.

Adjacent to the row of the second connectors 30, a third connector 35 is provided which, similar to the second connectors 30, can be provided with a connecting hose. The connecting hose connected to the third connector 35 provides a fluid connection with the cleaning unit 120 already mentioned.

A drive unit (not shown) is provided on the support member 10, which is configured as a pneumatic cylinder, for example. According to further modifications, the drive unit can also be configured as a hydraulic cylinder or a linear drive.

The drive unit is in connection with the frame element 12 and/or the resting element 11 and further engages with a side of the connector base 24. Therefore, a translational movement of the connector base 24 and thus also a translational movement of the first connector 20 relative to the resting element 11 can be achieved by a movement of the drive unit.

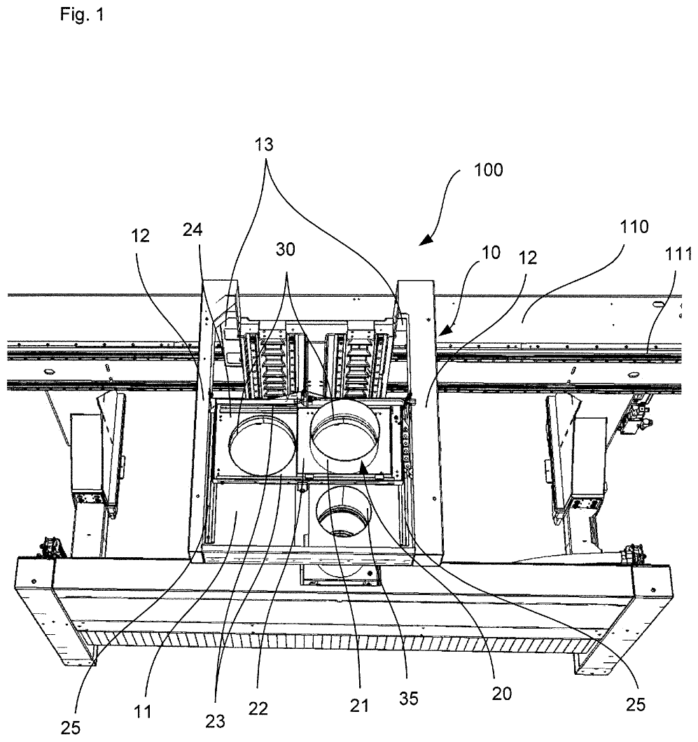

During operation of the processing machine 100, the first connector 20 can first be in fluid connection with one of the second connectors 30 (first operating position: FIG. 1) after the first connector 20 has been moved along the rails 23 and coupled to the corresponding second connector 30. The second connectors 30 are in fluid connection with one of the machining units of the processing machine 100, so that during machining with the corresponding machining unit a suction air flow can be provided and thus a removal of machining residues can be carried out.

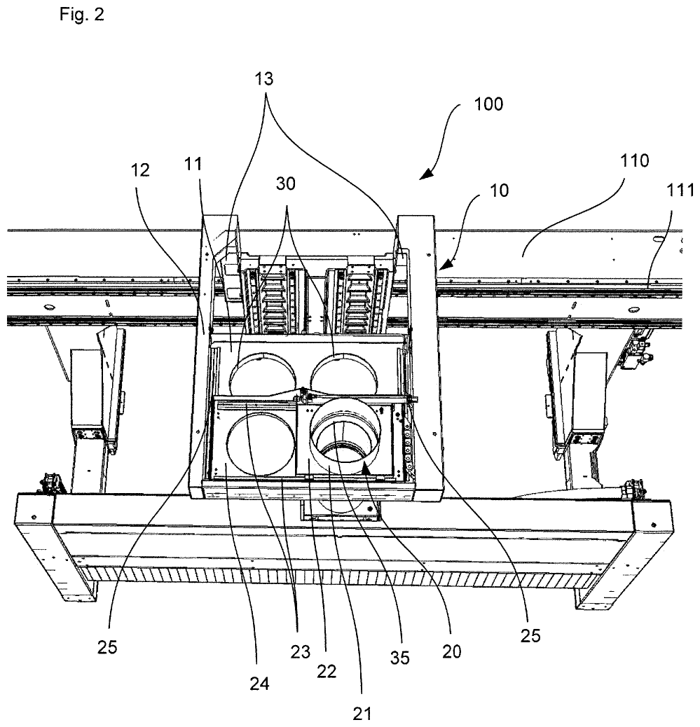

When the machining operation has been completed, the connector base 24 is moved along the rails 25. In this way, a fluid coupling can be established between the first connector 20 and the third connector 35 (second operating position: FIG. 2).

The third connector 35 is in fluid connection with the cleaning unit 120 provided on the housing of the support member 10, which provides an additional cleaning function after a machining operation with a machining unit. Thus, the cleaning unit is supplied with a suction air flow in the second operating position.

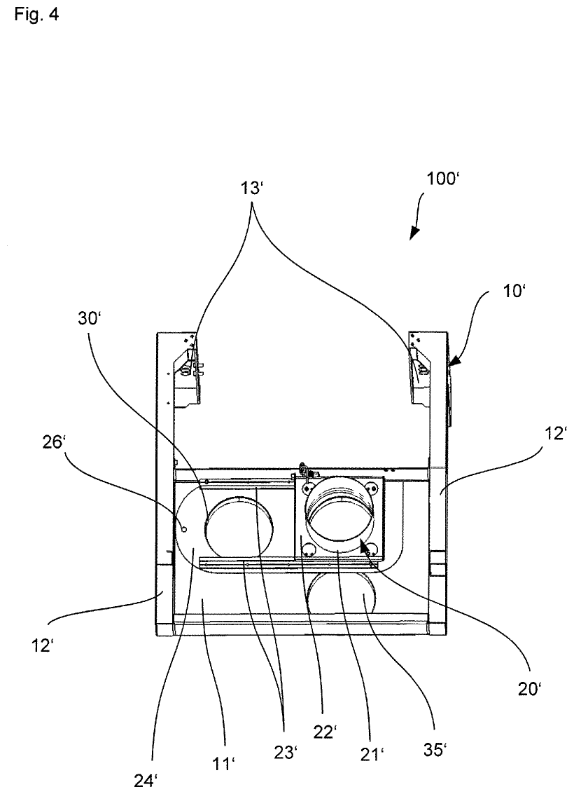

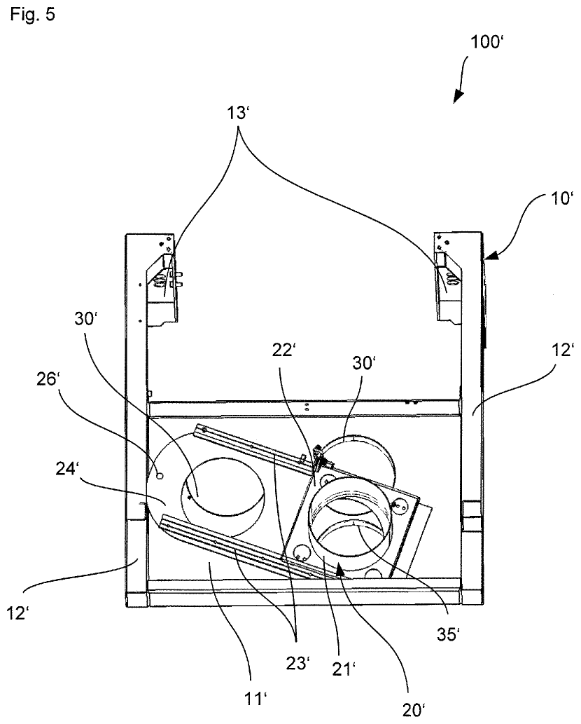

In FIGS. 4 to 5, a second embodiment of a processing machine 100′ is shown, which is configured in a similar manner as the processing machine 100 of the first embodiment, but has a different type of adjustment mechanism for moving a first connector. In particular, the adjustment mechanism causes a pivoting movement of a first connector which provides or can provide a connection with a main hose. In addition to the explanations provided below, reference is therefore also made to the description of the first embodiment.

In FIGS. 4 to 5, certain elements of the processing machine 100′ are not shown for the sake of clarity. In this respect, reference is made to the explanations regarding the first embodiment. This applies analogously to elements that are configured in a similar manner and/or have similar reference numbers.

Similar to the first embodiment, in the processing machine of the second embodiment, a support member 10′ can be moved along a beam-shaped support.

The support member 10′ comprises a resting element 11′ as well as frame elements 12′. Moreover, attachment areas 13′ are provided at which the support member 10′ is coupled to the aforementioned guide rail.

A connector base 24′ is movably arranged on the resting element 11′. In particular, a rotational joint 26′ is provided, so that the connector base 24′ on the resting element 11′ can be moved in a pivoting movement.

The resting element 11′ comprises a plurality of second connectors 30′, to which a connecting hose can be attached for connecting each of them to a machining unit. The second connectors 30′ are arranged in a row. When the first connector 20′ is moved along the rails 23′, the first connector 20′ can be aligned with and thus coupled to one of the second connectors 30′.

Adjacent to the row of the second connectors 30′, a third connector 35′ is provided which, similar to the second connectors 30′, can be provided with a connecting hose. The connecting hose connected to the third connector 35′ can, for example, provide a fluid connection with a cleaning unit already mentioned (FIG. 3) or the like.

Rails 23′ are provided on the connector base 24′, along which the first connector 20′ can be moved. The first connector 20′ comprises a connection unit 21′ that can be connected to a main hose (not shown) and a connection support 22′ that provides a sliding connection to the rails 23″.

Moreover, similar to the processing machine of the first embodiment, a drive unit (not shown) is provided on the support member 10′, which engages with the connector base 24′. Due to a movement of the drive unit, the connector base 24′ can be moved in a pivoting movement in order to establish a fluid connection between the first connector 20′ and the third connector 35′.

In the previous embodiments, a drive unit for moving the connector base 24, 24′ is described: however, a plurality of drive units can also be provided in order to perform a translational movement or a pivoting movement of the connector base and thus a corresponding movement of the first connector 20″.

Although in the previous embodiments a support member is described, which comprises two second connectors 30, 30′ as well as a third connector 35, 35′, said number of second connectors as well as of the third connector is not restricted to the example described. For example, three second connectors can be provided. Moreover, according to further modifications, it is possible to provide two or three third connectors.

In the previous embodiments, a translational movement and a rotational movement/pivoting movement for adjusting the position of the first connector were described. According to a further embodiment, the movements can be combined in order to change a position of the first connector.

According to a further embodiment, it can be provided to combine a movement of the first connector along the rails with a movement of the connector base in order to move the first connector from a second connector to the third connector or vice versa.

In the previous embodiments, the third connector is provided adjacent to one of the second connectors. However, the third connector can also be provided offset from the second connectors.

In the previous embodiments, the connector base 24, 24′ is provided on the resting element 11, 11′ such that the connector base 24, 24′ can slide on the resting element 11, 11′. According to a further modification of the embodiments described above, a lifting mechanism can also be provided in order to remove the connector base from the resting element before performing a translational and/or rotational movement and to guide it back in the direction of the resting element after performing the rotational and/or translational movement.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. A processing machine having a suction device for sucking off machining residues, comprising:
a first connector for a main fluid line; and
a plurality of second connectors for connecting fluid lines, wherein the first connector can be moved in a first direction such that a fluid connection with at least one of the second connectors can be established,
wherein the first connector can also be moved in a second direction, the second direction crossing the first direction.

2. The processing machine according to claim 1, comprising a first drive unit for moving the first connector in the first direction.

3. The processing machine according to claim 1, comprising a second drive unit for moving the second connector in the second direction.

4. The processing machine according to claim 1, wherein the second direction is a straight or curved direction.

5. The processing machine according to claim 1, wherein the first connector is accommodated on a connector base via at least one rail such that the first connector can be moved in the first direction, the connector base being able to be moved in the second direction.

6. The processing machine according to claim 1, further comprising at least a third connector, wherein a fluid connection can be established between the first connector and the third connector by a movement in the second direction.

7. The processing machine according to claim 6, wherein the second connectors are arranged in a row and the third connector is arranged adjacent to the row of the second connectors.

8. The processing machine according to claim 6, further comprising a cleaning unit which can be supplied with a suction air flow by means of via a connecting fluid line connected to the third connector.

9. The processing machine according to claim 1, comprising a support member for accommodating the first connector, wherein the second connectors are fixed to or formed on the support member.

10. The processing machine according to claim 9, wherein the support member can be moved along a beam-shaped base of the processing machine and/or the support member comprises a resting element which is configured, at least in sections, in a plate-shaped manner in order to form a resting plane for the first connector.

11. The processing machine according to claim 1, further comprising a plurality of machining units, wherein the machining units are each in fluid connection with one of the second connectors via a connecting fluid line.

12. A method of operating a suction device, comprising the steps of:
moving a first connector for a main fluid line in a first direction in order to establish a fluid connection with at least one second connector; and
moving the first connector in a second direction, the second direction crossing the first direction.

13. Method according to claim 12, wherein the first connector, by moving in the second direction, is positioned such that the first connector can be connected to a third connector.

14. Method according to claim 12, wherein the second direction is a straight or curved direction.

15. Method according to claim 12, wherein a suction air flow is provided after the fluid connection has been established.

16. The processing machine according to claim 2, wherein the first drive unit comprises a pneumatic cylinder, a hydraulic cylinder, or a servomotor.

17. The processing machine according to claim 3, wherein the second drive unit comprises a pneumatic cylinder, a hydraulic cylinder, or a servomotor.
